(19) United States
(12) Patent Application Publication
(10) Pub. No.: US 2012/0146755 A1
(43) Pub. Date: Jun. 14, 2012

(54) INDUCTOR

(75) Inventor: Chih Ping Shao, Keelung City (TW)

(73) Assignee: LOTES CO., LTD, Keelung City (TW)

(21) Appl. No.: 13/159,808

(22) Filed: Jun. 14, 2011

(30) Foreign Application Priority Data
Dec. 8, 2010 (CN) 201020663976.4

(51) Int. Cl. H01F 27/28

(52) U.S. Cl. 336/182

(57) ABSTRACT

In one embodiment, the inductor includes: a substrate, arranged with multiple lower conducting layers, a magnetic core, disposed on the substrate, and an insulating cover, covering the substrate and wrapping the magnetic core. Multiple upper conducting layers are arranged on a surface of the insulating cover. The upper conducting layers and the lower conducting layers are alternately connected to form at least one coil winding around the magnetic core. Two ends of the coil are respectively used to conduct external electrical signals.

### CROSS-REFERENCE TO RELATED APPLICATIONS

This non-provisional application claims priority under 35 U.S.C. §119(a) on Patent Application No. 201020663976.4 filed in China on Dec. 8, 2010, the entire contents of which are hereby incorporated by reference.

### FIELD OF THE INVENTION

The present invention relates to an inductor, and more particularly to an inductor which does not require winding a coil.

### BACKGROUND OF THE INVENTION

An inductor commonly seen in the industry has a magnetic core and an enameled wire wound on an outer periphery of the magnetic core, in which the enameled wire is wound manually or automatically in advance.

In order to obtain more inductance, generally it is necessary to superpose the enameled wire during the coil winding process. Thus, the insulating layer of the enameled wire is easily scratched during the coil winding process. In addition, it is necessary to reserve a segment at the front end of the enameled wire when the enameled wire is wound so as to fasten the enameled wire during the winding process, which inevitably results in a waste of the enameled wire after the winding operation is completed, thereby increasing the cost of material. Besides, the manual coil winding is time- and labor-consuming and inefficient, while the automatic coil winding results in a high cost. Furthermore, the enameled wire and the magnetic core are independent components and occupy a lot of space, which is not conducive to miniaturization of the product design.

Therefore, a heretofore unaddressed need exists in the art to address the aforementioned deficiencies and inadequacies.

### SUMMARY OF THE INVENTION

In one aspect, the present invention is directed to an inductor which does not require winding a coil.

In one embodiment, the present invention provides and inductor. The inductor includes: a substrate, arranged with multiple lower conducting layers, a magnetic core, disposed on the substrate, and an insulating cover, covering the substrate and wrapping the magnetic core. Multiple upper conducting layers are arranged on a surface of the insulating cover. The upper conducting layers and the lower conducting layers are alternately connected to form at least one coil winding around the magnetic core. Two ends of the coil are respectively used to conduct external electrical signals.

Compared with the prior art, multiple upper conducting layers are arranged on the surface of the insulating cover, and multiple lower conducting layers are arranged on the substrate, so that the coil can be formed simply by alternately connecting the upper conducting layers and the lower conducting layers. Therefore, in one aspect, the inductor of the present invention does not require winding a coil in advance, which can save much labor and material and improve the working efficiency. Furthermore, as the upper conducting layers located on the insulating cover are directly arranged on the surface of the insulating cover, no extra space is occupied, and thus the design is miniaturized.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment, and wherein:

FIG. 1 is a three-dimensional exploded view of a first embodiment of the present invention;

FIG. 2 is a top view of FIG. 1 after assembly;

FIG. 3 is a three-dimensional exploded view of an inductor according to a second embodiment of the present invention;

FIG. 4 is a top view of FIG. 3 after assembly;

FIG. 5 is a schematic structural view of a first coil of an inductor according to a third embodiment of the present invention;

FIG. 6 is a schematic structural view of a second coil of the inductor according to the third embodiment of the present invention;

FIG. 7 is a schematic view of an assembled structure of the inductor according to the third embodiment of the present invention;

FIG. 8 is a sectional view of an inductor according to a fourth embodiment of the present invention;

FIG. 9 is a three-dimensional exploded view of an inductor according to a fifth embodiment of the present invention;

FIG. 10 is a sectional view of FIG. 9 after assembly;

FIG. 11 is a three-dimensional exploded view of an inductor according to a sixth embodiment of the present invention; and

FIG. 12 is a sectional view of FIG. 11 after assembly.

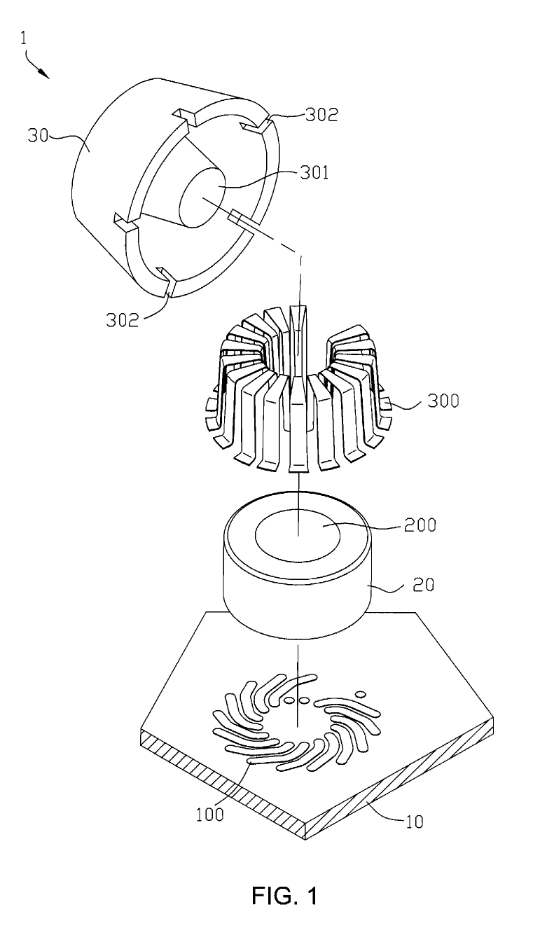

List of Reference Numerals in FIGS. 1-12:

| | | |
|---|---|---|
| Inductor 1 | Substrate 10 | Magnetic core 20 |
| Insulating cover 30 | Coil 40 | Connecting terminal 50 |
| Insulating layer 60 | Split ring 70 | |

| | |
|---|---|
| Lower conducting layer 100 | Grounding terminal 101 |
| First lower conducting | Second lower conducting |
| layer 110 | layer 120 |
| First grounding terminal 111 | Second grounding terminal 112 |
| Through hole 200 | |
| Upper conducting layer 300 | Groove 301 |
| Deformable opening 302 | First insulating cover 31 |
| Second insulating cover 32 | First upper conducting layer 310 |
| Second upper conducting layer 320 | |
| First coil 410 | Second coil 420 |
| First connecting terminal 510 | Second connecting terminal 520 |

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

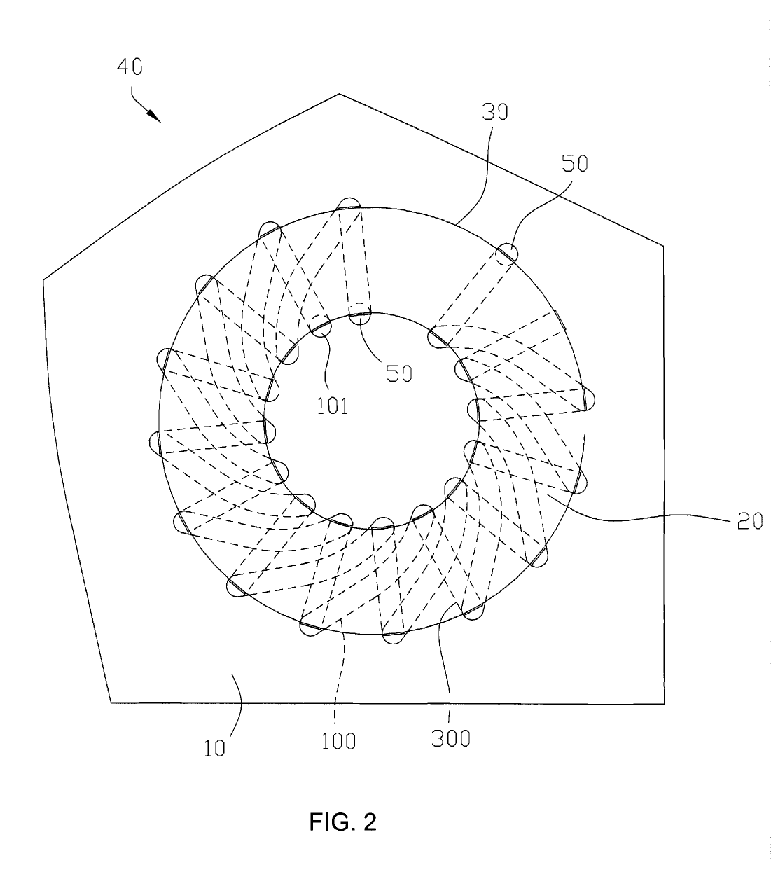

Referring to FIGS. 1 and 2, a first embodiment of the present invention provides an inductor 1, including: a substrate 10, arranged with multiple lower conducting layers 100, a magnetic core 20, disposed on the substrate 10, and an insulating cover 30, covering the substrate 10 and wrapping the magnetic core 20, in which multiple upper conducting layers 300 are arranged on a surface of the insulating cover 30.

Referring to FIGS. 1 and 2, the magnetic core 20 has an annular shape, and a through hole 200 is formed through a top surface of the magnetic core 20. A groove 301 entering the through hole 200 is recessed in a top portion of the insulating cover 30 to cooperate with the magnetic core 20. The upper conducting layers 300 and the lower conducting layers 100 are all in the shape of an elongated strip, and are respectively disposed on the surface of the insulating cover 30 and the substrate 10 through chemical treatment. The chemical treatment includes, for example, but is not limited to, etching, transfer printing, and metal interlayer deposition (MID) chemical plating. The upper conducting layers 300 may be disposed on an inner surface of the insulating cover 30, or disposed on an outer surface of the insulating cover 30. Preferably, in this embodiment, the upper conducting layers 300 are disposed on the inner surface of the insulating cover 30. Multiple deformable openings 302 are formed on a side wall of the insulating cover 30 to cooperate with the upper conducting layers 300. The deformable openings 302 and the upper conducting layers 300 are disposed at an interval. The deformable openings 302 are formed upward from a bottom portion of the side wall of the insulating cover 30, and the deformable openings 302 are formed through the side wall of the insulating cover 30 from inside to outside.

Referring to FIGS. 1 and 2, the upper conducting layers 300 located on the inner surface of the insulating cover 30 and the lower conducting layers 100 located on the substrate 10 are alternately connected. That is, a head end and a tail end of each of the lower conducting layers 100 are connected with different ends of the two adjacent upper conducting layers 300, and finally a coil 40 in the shape of an annular sawtooth pulse is formed. Two connecting terminals 50 are reserved on the coil 40 to conduct external electrical signals. The two connecting terminals 50 are respectively located at the first position and the last position of a sequence of the upper conducting layers 300 and the lower conducting layers 100.

Referring to FIGS. 1 and 2, a grounding terminal 101 connected to the coil 40 is disposed on the substrate 10.

In operation, referring to FIGS. 1 and 2, firstly the upper conducting layers 300 and the lower conducting layers 100 are disposed on the inner surface of the insulating cover 30 and the substrate 10 through chemical treatment. Then, the grounding terminal 101 is printed on the substrate 10. Further, the magnetic core 20 is placed on the substrate 10, and the head end and tail end of each of the lower conducting layers 100 are soldered on different ends of the two adjacent upper conducting layers 300 to form the coil 40. At the same time, the grounding terminal 101 is connected to the coil 40. The two connecting ends 50 of the coil 40 are connected to external electrical signals, so that the coil 40 forms an active loop and provides a current to drive the coil 40 to work and generate a magnetic field. The coil 40 is applicable to a circuit structure such as a rectification circuit and a filter circuit. Normally, the material of the insulating cover 30 is different from that of the substrate 10. When the upper conducting layers 300 on the insulating cover 30 are soldered to the lower conducting layers 100 on the substrate 10, as the expansion coefficient of the insulating cover 30 is different from that of the substrate 10, poor soldering such as missing solder or false soldering occurs. Since the deformable openings 302 are formed, the expansion difference from different materials during high-temperature soldering can be reduced, thereby ensuring a good soldering effect.

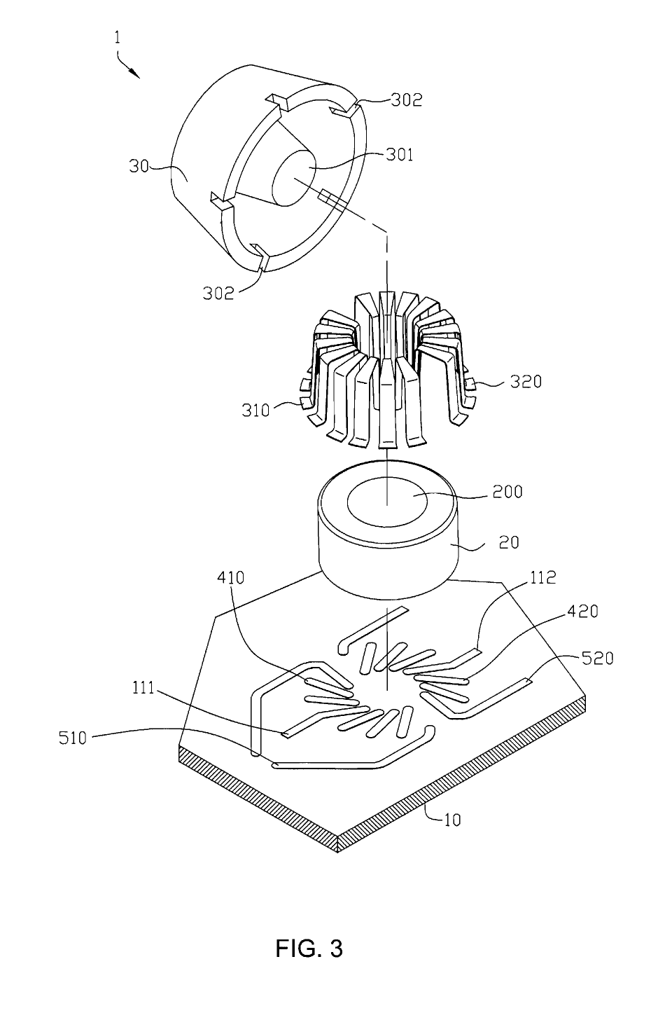

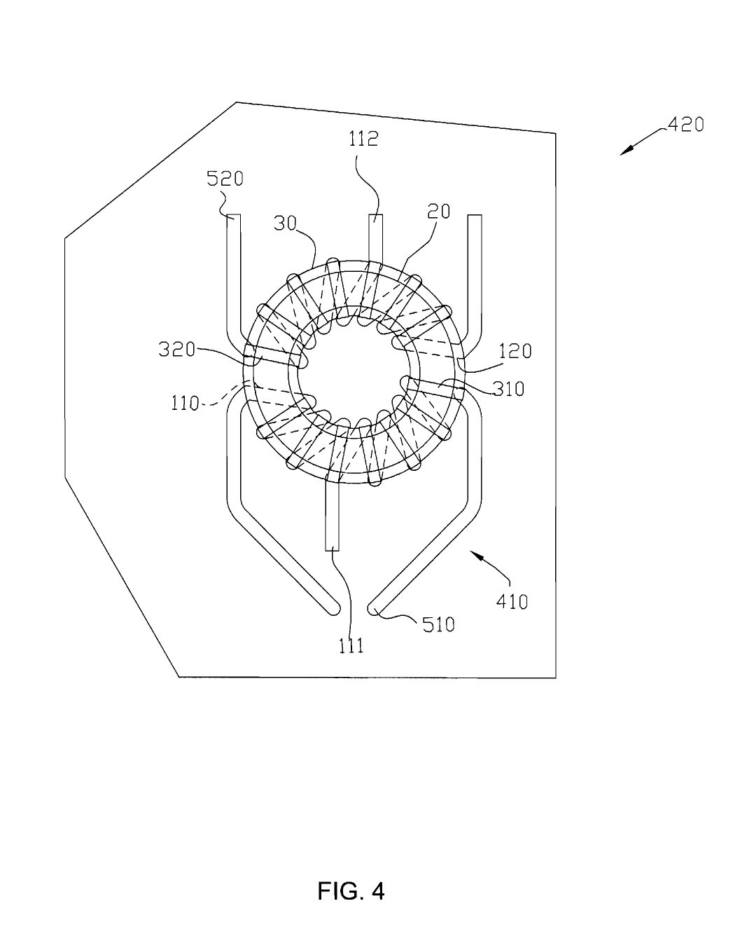

Referring to FIGS. 3 and 4, a second embodiment of the present invention is provided. The difference between the second embodiment and first embodiment lies in that, multiple first upper conducting layers 310 and multiple second conducting layers 320 are disposed on the surface of the insulating cover 30 through chemical treatment. The first upper conducting layers 310 and the second upper conducting layers 320 are arranged on two sides of the surface of the insulating cover 30. Multiple first lower conducting layers 110 and multiple second lower conducting layers 120 are respectively disposed on the substrate 10 corresponding to the first upper conducting layers 310 and the second upper conducting layers 320. The first upper conducting layers 310 are alternately connected with the first lower conducting layers 110. A head end and a tail end of each of the first lower conducting layers 110 are respectively correspondingly connected to different ends of the two adjacent first upper conducting layers 310, so as to finally form a first coil 410 in the shape of an annular sawtooth pulse. Two first connecting terminals 510 are reserved on the first coil 410 to conduct external electrical signals. The second upper conducting layers 320 are alternately connected with the second lower conducting layers 120. A head end and a tail end of each of the second lower conducting layers 120 are respectively correspondingly connected to different ends of the two adjacent second upper conducting layers 320, so as to finally form a second coil 420 in the shape of an annular sawtooth pulse. Two second connecting terminals 520 are reserved on the second coil 420 to conduct external electrical signals. The first coil 410 and the second coil 420 are disposed on the magnetic core 20 at an interval. A first grounding terminal 111 and a second grounding terminal 112 are disposed on the substrate 10, which are respectively connected to the first coil 410 and the second coil 420. Moreover, the first coil 410 and the second coil 420 are coupled, and are applicable to a circuit structure such as a voltage transformation circuit.

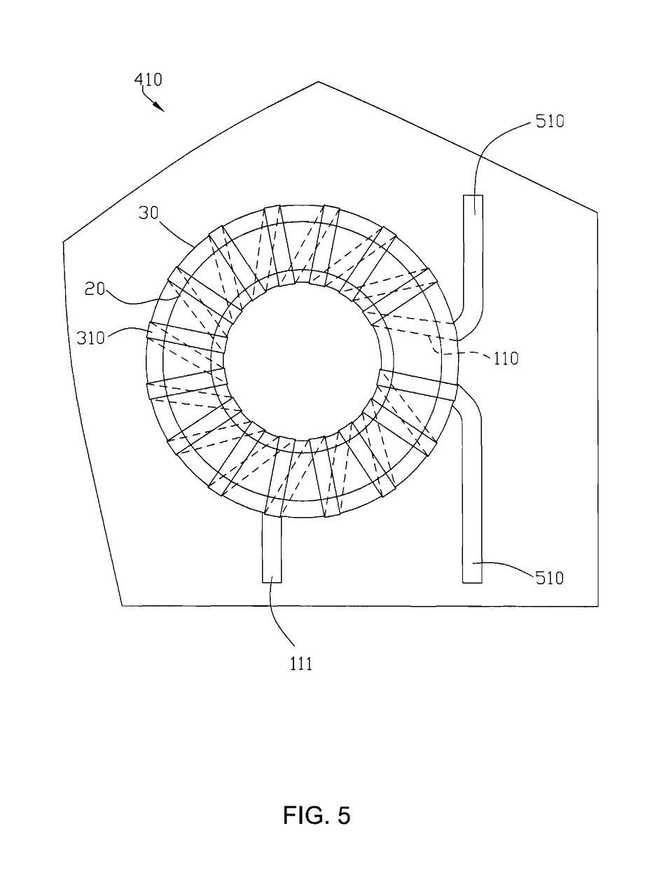

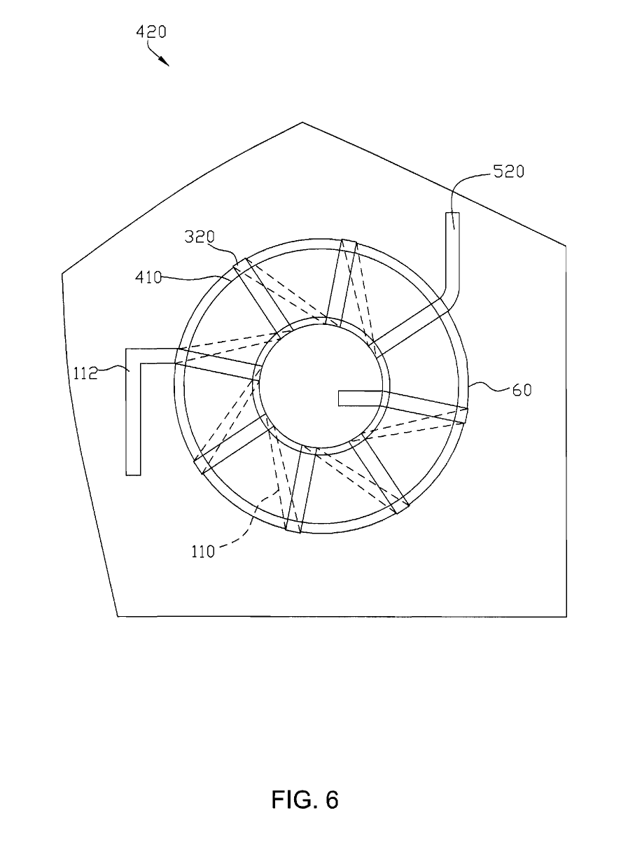

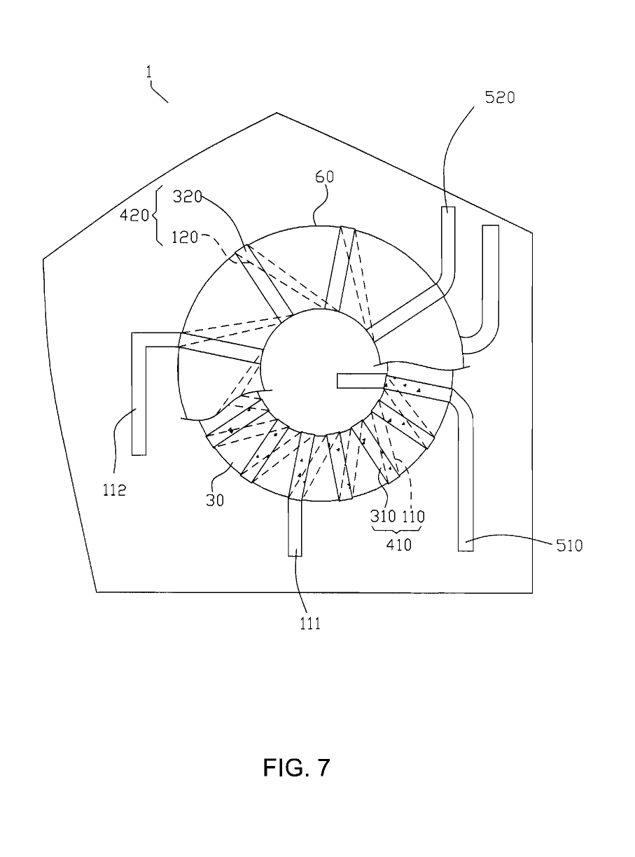

Referring to FIGS. 5-7, a third embodiment of the present invention is provided. The difference between the third embodiment and the second embodiment lies in that, referring to FIG. 5, the first upper conducting layers 310 are directly arranged on the surface of the insulating cover 30 and are alternately connected with the first lower conducting layers 110 arranged on the substrate 10 to form a first coil 410. Afterward, an insulating layer 60 is plated on an outer periphery of the first coil 410, so that the first coil 410 is isolated from the outside, and only the first connecting terminal 510 is reserved to conduct external electrical signals. Moreover, a first grounding terminal 111 located on the substrate 10 is conducted to the first coil 410. Then, referring to FIG. 6, the second upper conducting layers 320 are disposed on the insulating layer 60 through chemical treatment, and are alternately connected with the second lower conducting layers 120 to form a second coil 420. Only the second connecting terminal 520 is reserved to conduct external electrical signals. Moreover, a second grounding terminal 112 on the substrate 10 is conducted to the second coil 420. A connection direction of the first upper conducting layers 310 and the first lower conducting layers 110 is opposite to that of the second upper conducting layers 320 and the second lower conducting layers 120. Therefore, referring to FIG. 7, the first coil 410 and the second coil 420 are disposed on the magnetic core 20 in a staggered manner, and the first coil 410 and the second coil 420 are coupled.

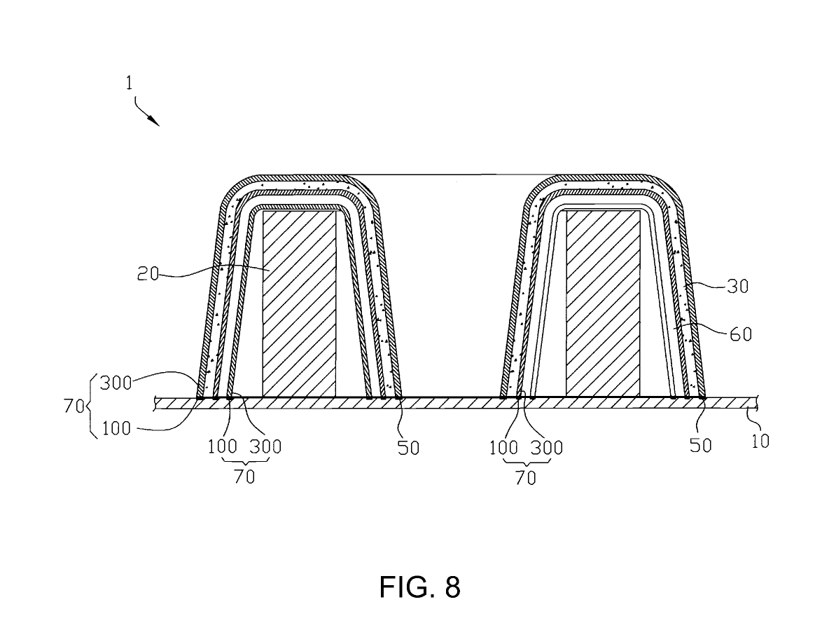

Referring to FIG. 8, a fourth embodiment of the present invention is provided. The difference between the fourth embodiment and the first embodiment lies in that, the coil 40 formed by alternately connecting the upper conducting layers 300 and the lower conducting layers 100 winds along the surface of the magnetic core 20 repeatedly in a superposing manner. That is, the coil 40 has multiple split rings 70 connected with each other. Each of the split rings 70 is formed by one of the upper conducting layers 300 and one of the lower conducting layers 100 that are connected. The upper conducting layer 300 located at the first position of the sequence is reserved. The lower conducting layer 100 located on the same split ring 70 as the reserved upper conducting layer 300 is connected to the next split ring 70. After the multiple split rings 70 are connected according to a prearranged direction and wind along the magnetic core 20 for one circle, the insulating layer 60 is plated on the multiple split rings 70 that are already connected. Only the lower conducting layer 100 located on the last split ring 70 of the sequence is reserved. Then, the upper conducting layers 300 are disposed on the insulating layer 60 through chemical treatment. At this time, the split rings 70 located on the magnetic core 20 and the split rings 70 located on the insulating layer 60 are layered in an inner-outer pattern with magnetic induction generated from the magnetic core 20 as a center. Afterward, the reserved lower conducting layer 110 is connected with the upper conducting layer 300 disposed on the insulating layer 60 in the same manner, so as to form the coil 40. Such a connection manner increases the length of the coil and can increase the inductance of the inductor 1.

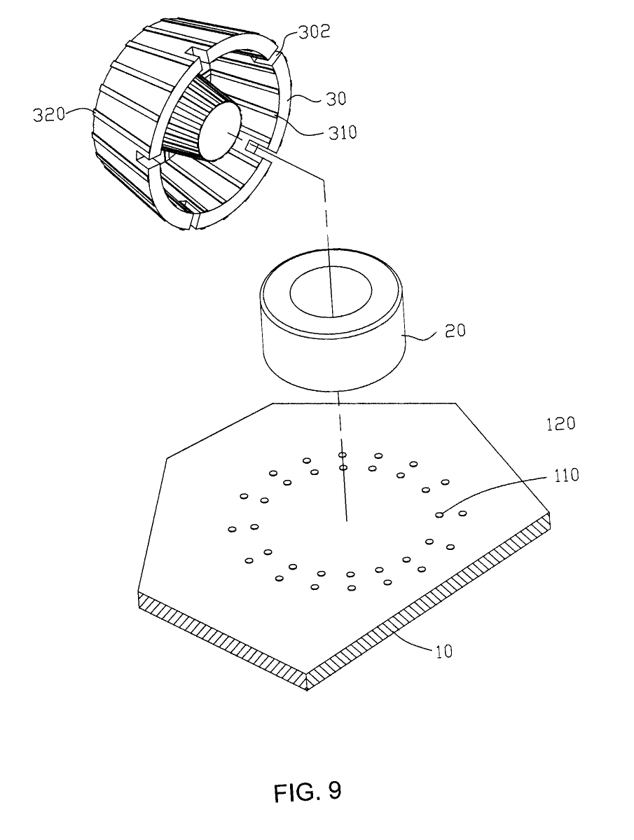

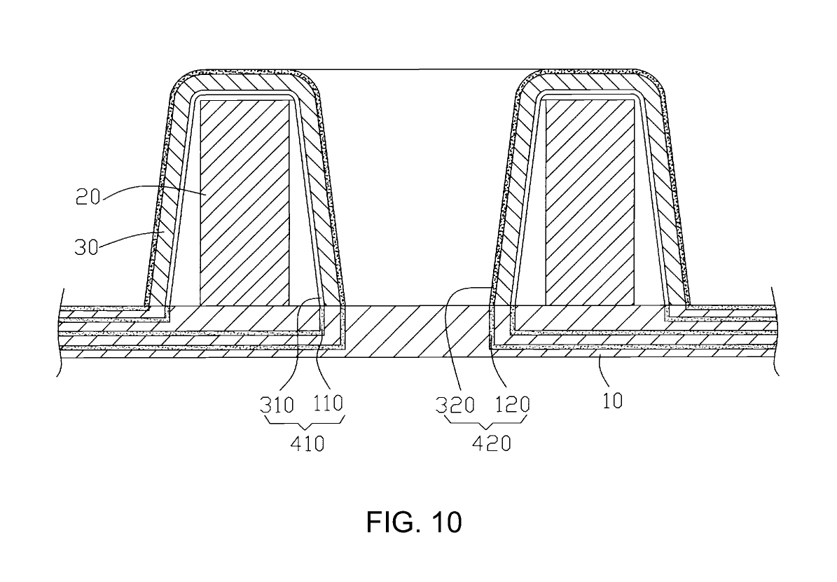

Referring to FIGS. 9 and 10, a fifth embodiment of the present invention is provided. The difference between the fifth embodiment and the first embodiment lies in that, the upper conducting layers 300 may not only be arranged on the inner surface of the insulating cover 30, but also arranged on the outer surface of the insulating cover 30. The substrate 10 includes multiple layers to cooperate with the upper conducting layers 300 arranged at different locations. In this embodiment, the multiple layers refer to two layers in particular, and each layer is used for arranging the layered lower conducting layers 100. The upper conducting layers 300 arranged on the inner surface of the insulating cover 30 and the upper conducting layers 300 arranged on the outer surface of the insulating cover 30 are connected with the lower conducting layers 100 arranged on different layers of the substrate 10 according to the connection manner in the first embodiment, and in the same connection direction. In this manner, two coils 40 are formed, and the two coils 40 are superposed over each other.

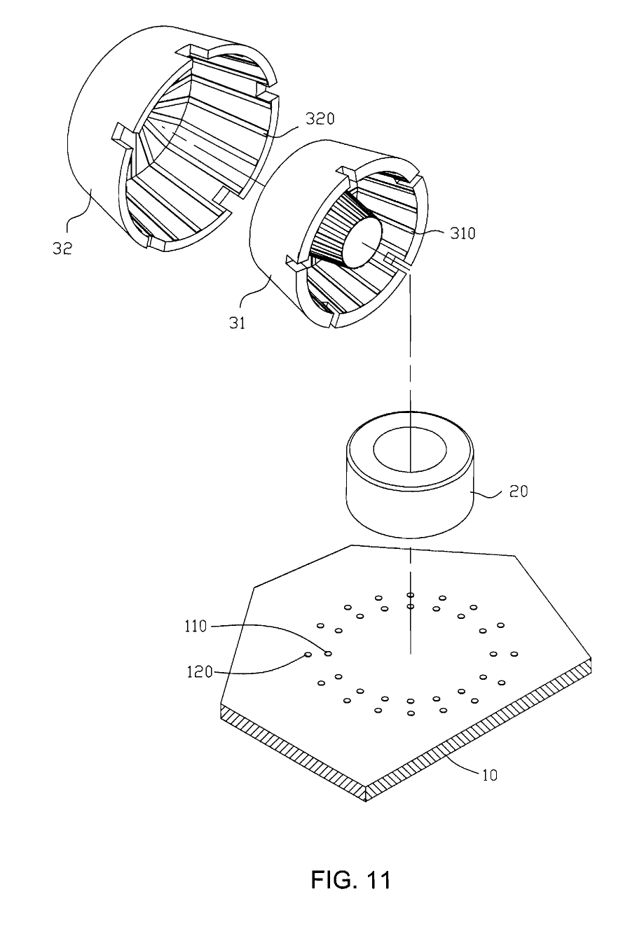

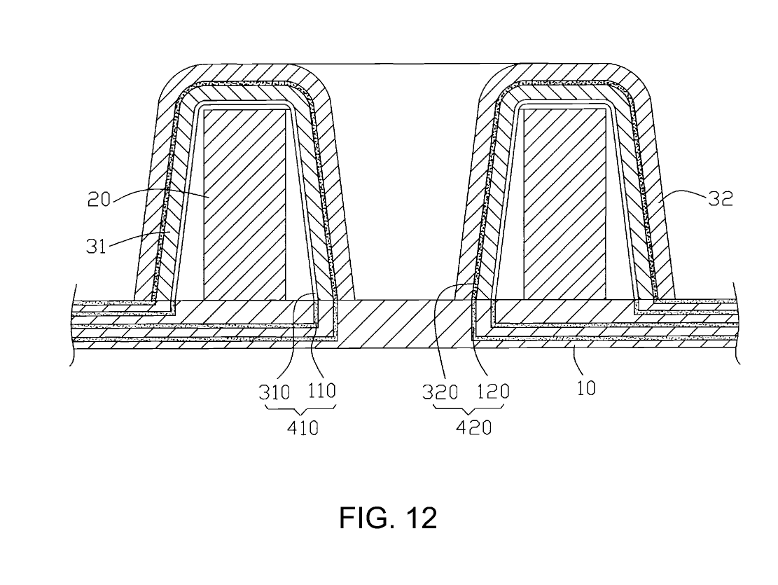

Referring to FIGS. 11 and 12, a sixth embodiment of the present invention is provided. The difference between the sixth embodiment and the first embodiment lies in that, the inductor 1 includes a first insulating cover 31 and a second insulating cover 32 that are stacked upon each other. Multiple first upper conducting layers 310 and multiple second upper conducting layers 320 are arranged on inner surfaces of the first insulating cover 31 and the second insulating cover 32, respectively. Multiple first lower conducting layers 110 and multiple second lower conducting layers 120 are arranged on the substrate 10 to cooperate with the first upper conducting layers 310 and the second upper conducting layers 320. Moreover, the first upper conducting layers 310 and the first lower conducting layers 110, as well as the second upper conducting layers 320 and the second lower conducting layers 120 are respectively connected according to the connection manner in the first embodiment. In this manner, the first upper conducting layers 310 located on the first insulating cover 31 and the first lower conducting layers 110 located on the substrate 10 can form a coil 410, and the second upper conducting layers 320 located on the second insulating cover 32 and the second lower conducting layers 120 located on the substrate 10 can form a coil 420. Moreover, the coil 410 and the coil 420 are superposed over each other.

Based on the above, the inductor of the present invention, among other things, has the following advantages.

1. As the upper conducting layers and the lower conducting layers are respectively arranged on the surface of the insulating cover and the substrate, the coil can be formed simply by alternately connecting the upper conducting layers and the lower conducting layers; therefore, the inductor does not require winding a coil in advance, which can save much labor and material and improve the working efficiency.

2. As the upper conducting layers are directly arranged on the surface of the insulating cover, no extra space is occupied, and thus the design is miniaturized.

3. As the connecting terminals are connected to external electronic signals so that the coil forms an active loop and a current is provided to drive the magnetic induction coil to work to generate a magnetic field, the coil is applicable to a circuit structure such as a rectification circuit and a filter circuit.

4. As the coil loops are coupled to each other, the coil loops are applicable to a structure for realizing functions such as voltage transformation.

5. As the coil loops are superposed over each other, the inductance of the inductor can be increased.

6. As the deformable openings are formed, the expansion difference from different materials during high-temperature soldering can be reduced, thereby ensuring a good soldering effect.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An inductor, comprising:
a substrate, arranged with multiple lower conducting layers;
a magnetic core, disposed on the substrate; and
an insulating cover, covering the substrate and wrapping the magnetic core, wherein multiple upper conducting layers are arranged on a surface of the insulating cover,
wherein the upper conducting layers and the lower conducting layers are alternately connected to form at least one coil winding around the magnetic core, and two ends of the coil are respectively used to conduct external electrical signals.

2. The inductor according to claim 1, wherein the upper conducting layers and the lower conducting layers are alternately connected to form at least two coils, and the two coils are coupled.

3. The inductor according to claim 2, wherein the coils are disposed on the magnetic core at an interval.

4. The inductor according to claim 2, wherein the coils are disposed on the magnetic core in a staggered manner.

5. The inductor according to claim 1, wherein the coil winds along an outer periphery of the magnetic core repeatedly in a superposing manner, the coil has multiple split rings connected with each other, each split ring is formed by one of the upper conducting layers and one of the lower conducting layers that are connected, and at least a part of the split rings of the coil are layered in an inner-outer pattern with the magnetic core as a center.

6. The inductor according to claim 5, wherein an inner surface and an outer surface of the insulating cover are respectively used for arranging the upper conducting layers of the layered different split rings.

7. The inductor according to claim 5, wherein the substrate comprises multiple layers, and the different layers of the substrate are respectively used for arranging the lower conducting layers of the layered different split rings.

8. The inductor according to claim 1, wherein more than two stacked insulating covers are disposed on the substrate.

9. The inductor according to claim 1, wherein a through hole is formed through a top surface of the magnetic core, and a groove entering the through hole is correspondingly recessed in a top portion of the insulating cover.

10. The inductor according to claim 1, wherein several deformable openings are formed at an interval on a side wall of the insulating cover, and the deformable openings are formed upward from a bottom portion of the side wall of the insulating cover.
